(19) United States
(12) Patent Application Publication
(10) Pub. No.: US 2010/0330418 A1
(43) Pub. Date: Dec. 30, 2010

(54) POLYMER ELECTROLYTE, BATTERY AND METHOD

(75) Inventors: Shishuo Liang, Shenzhen (CN); Yong Luo, Shenzhen (CN); Zhengri Yu, Shenzhen (CN)

Correspondence Address: BRINKS HOFER GILSON & LIONE, P.O. BOX 10395, CHICAGO, IL, 60610, US

(73) Assignee: BYD Co. Ltd., Shenzhen (CN)

(21) Appl. No.: 12/825,041

(22) Filed: Jun. 28, 2010

(30) Foreign Application Priority Data
Jun. 30, 2009 (CN) 200910150780.7

(51) Int. Cl. H01M 10/26

(52) U.S. Cl. 429/207

(57) ABSTRACT

A polymer electrolyte comprises a first polymeric matrix, a second polymeric matrix, and a lithium salt. The first polymeric matrix comprises pores. The second polymeric matrix is disposed in at least some of the pores of the first polymeric matrix. The lithium salt is disposed in at least some of the pores of the first polymeric matrix.

### CROSS-REFERENCE TO RELATED APPLICATION

The present application claims priority of and benefits to Chinese Patent Application No. 200910150780.7, filed with State Intellectual Property Office of the People's Republic of China (SIPO) on Jun. 30, 2009, the entirety of which is hereby incorporated by reference.

### FIELD

The disclosure relates to a polymer electrolyte for a battery, a method for preparing the same, and a battery comprising the same.

### BACKGROUND

Polymer lithium batteries have high specific energy, good safety performances and advanced manufacturing processes. Polymer membranes are not only an important part of polymer lithium batteries, but also an important factor determining the performance of batteries. Polymer membranes are required to have uniform porous structures, high porosities, ionic conductivities, mechanical strengths and stable interfacial properties. Moreover, the prior methods of manufacturing porous polymer membranes have complex processes, long operation cycles, and high demands for equipments and environments.

### SUMMARY

In one aspect, a polymer electrolyte comprises a first polymeric matrix, a second polymeric matrix, and a lithium salt. The first polymeric matrix comprises pores. The second polymeric matrix is disposed in at least some of the pores of the first polymeric matrix. The lithium salt is disposed in at least some of the pores of the first polymeric matrix.

In another aspect, a method of preparing a polymer electrolyte, comprises the steps of: preparing a first polymeric matrix comprising pores; applying a polymer solution to the first polymeric matrix; removing the solvent from the polymer solution so as to dispose a second polymeric matrix within the pores of the first polymeric matrix; and applying a lithium salt solution to thereby dispose lithium salt within the pores of the first polymeric matrix.

In yet another aspect, a battery comprises a cathode, an anode, and a polymer electrolyte. The polymer electrolyte comprises a first polymeric matrix, a second polymeric matrix, and a lithium salt. The first polymeric matrix comprises pores. The second polymeric matrix is disposed in at least some of the pores of the first polymeric matrix. The lithium salt is disposed in at least some of the pores of the first polymeric matrix.

### BRIEF DESCRIPTION OF THE DRAWINGS

Exemplary embodiments of the present disclosure will be described in detail based on the following figures.

FIG. 1 shows a cross-sectional view of the polymeric matrices according to one embodiment of the present disclosure. The polymeric matrices include the first polymeric matrix and the second polymeric matrix disposed in the pores of the first polymeric matrix.

FIG. 2 shows a flowchart for preparing a polymer electrolyte according to one embodiment of the present disclosure.

FIG. 3 shows a Scanning Electron Micrograph (SEM) of a surface of a first polymeric matrix according to EMBODIMENT 1 (20 kV; ×2,000).

FIG. 4 shows an SEM of a surface of the polymeric matrices according to EMBODIMENT 1. The polymeric matrices include the first polymeric matrix and the second polymeric matrix disposed in the pores of the first polymeric matrix (20 kV; ×2,000).

### DETAILED DESCRIPTION

It will be appreciated by those of ordinary skill in the art that the disclosure can be embodied in other specific forms without departing from the spirit or essential character thereof. The presently disclosed embodiments are therefore considered in all respects to be illustrative and not restrictive.

A polymer electrolyte comprises a first polymeric matrix, a second polymeric matrix, and a lithium salt. The first polymeric matrix comprises pores. The second polymeric matrix is disposed in at least some of the pores of the first polymeric matrix. The lithium salt is disposed in at least some of the pores of the first polymeric matrix. The lithium salt is in a form of a solution and/or a gel disposed in the first polymeric matrix. The second polymeric matrix also comprises pores. At least some of the lithium salt is disposed within at least some of the pores of the second polymeric matrix.

The first polymeric matrix is the main structure of the polymer electrolyte to accommodate the lithium salt, and to keep the lithium salt stable in the polymer electrolyte batteries. Meanwhile, the cathode and anode of the battery are separated by the first polymeric matrix.

FIG. 1 shows a structure of polymeric matrices. The matrices include the first polymeric matrix 11 and the second polymeric matrix 12. At least part of the second polymeric matrix 12 is disposed in at least some of the pores of the first polymeric matrix 11. At least some of the pores of the first polymeric matrix 11 are not completely filled with the second polymeric matrix 12. Thus, the first polymeric matrix 11 and the second polymeric matrix 12 provide a composite porous structure to accommodate the lithium salt. The composite porous structure makes the pores of the matrices condense. Therefore, it does not require a significant increase of the thickness of the polymer electrolyte to improve its mechanical properties. Moreover, the composite porous structure may also increase the retention capacity of the matrices to the lithium salt, and may improve the ionic conductivity of the polymer electrolyte at room temperature. Preferably, the weight ratio of the first polymeric matrix to the second polymeric matrix is from about 1 to about 15. More preferably, the weight ratio is from about 2 to about 10.

The first polymeric matrix forms the main structure of the electrolyte and provides space for the second polymeric matrix. In some embodiments, the first polymeric matrix has large apertures and high porosity, and at least some of the pores are connected. Preferably, the porosity of the first polymeric matrix is from about 20% to about 85%. The average diameter of the pores is from about 0.05 μm to about 1 μm. The thickness of the first polymeric matrix is from about 4 μm to about 50 μm. Preferably, the porosity of the first polymeric matrix is from about 30% to about 80%. More preferably, the average diameter of the pores is from about 0.05 μm to about 0.2 μm. The thickness of the first polymeric matrix is from about 5 μm to about 25 μm. Porosity is defined as the ratio of volume of the pores to the total volume of the matrix. In some embodiments, the average pore size and the porosity of the matrix are measured by the mercury intrusion method.

The first polymeric matrix is formed from a first polymer. The second polymeric matrix is formed from a second polymer. The first and second polymers can be any suitable polymers. Preferably, the first and second polymers are independently selected from the group consisting of polyolefin, polymethacrylate, polyether, polysulfone, and combinations thereof.

In some embodiments, the first polymer is selected from the group consisting of polyvinylidene fluoride-hexafluoropropene (PVDF-HFP) copolymer, polyvinylidene fluoride-chlorotrifluoroethylene (PVDF-CTFE) copolymer, polyvinylidene fluoride (PVDF), polymethacrylate (PMA), polyethylene oxide (PEO), poly(oxypropylene), polyacrylonitrile (PAN), polyvinylchloride (PVC), polyvinyl acetate (PVAc), polyvinylpyrrolidone (PVP), polysulfone (PSF), polyethersulfone (PES), polyacrylamide (PAM), and combinations thereof. In some embodiments, polyvinylidene fluoride-hexafluoropropene (PVDF-HFP) copolymer or polyvinylidene fluoride-chlorotrifluoroethylene (PVDF-CTFE) copolymer is a random copolymer, a block copolymer, or an alternating copolymer. Preferably, polyvinylidene fluoride-hexafluoropropene (PVDF-HFP) copolymer or polyvinylidene fluoride-chlorotrifluoroethylene (PVDF-CTFE) copolymer is a random copolymer. The weight-average molecular weight of the first polymer can be about 20,000 to about 4,000,000 Daltons. Preferably, the weight-average molecular weight of the first polymer is from about 100,000 to about 2,500,000 Daltons.

In some embodiments, the second polymer is selected from the group consisting of polyvinylidene fluoride-hexafluoropropene (PVDF-HFP) copolymer, polyvinylidene fluoride-chlorotrifluoroethylene (PVDF-CTFE) copolymer, polyvinylidene fluoride (PVDF), polymethacrylate (PMA), polyethylene oxide (PEO), poly(oxypropylene), polyacrylonitrile (PAN), polyvinylchloride (PVC), polyvinyl acetate (PVAc), polyethyleneglycol dimethylether, polyvinylpyrrolidone (PVP), polysulfone (PSF), polyethersulfone (PES), polyacrylamide (PAM), and combinations thereof. The weight-average molecular weight of the second polymer can be about 20,000 to about 4,000,000 Daltons. Preferably, the weight-average molecular weight of the second polymer is from about 100,000 to about 1,500,000 Daltons.

In some embodiments, the first and the second polymers are different polymers. In other embodiments, the first and the second polymers are the same polymers, or the same type polymers having different weight-average molecular weights. Here the same polymer is referred to the polymer with the same monomer and the same weight-average molecular weight. The different polymers are referred to polymers with different monomers. The same type polymers are the polymers with the same monomer but different weight-average molecular weights. Because of the polymers with different monomers have different physical and chemical properties, and the polymers with different weight-average molecular weight have different segmental movement properties, the difference of properties may further enhance the ability of maintaining the lithium salt in the polymeric matrices. In some embodiments, the first and the second polymers are the same type polymers with different weight-average molecular weight. The difference is from about 20,000 to about 2,000,000 Daltons.

In some embodiments, at least part of the second polymer is disposed in at least part of the pores of the first polymeric matrix. Part of the second polymer is coated on the surface of the first polymeric matrix. In some embodiments, the thickness of the second polymer coated on the first polymeric matrix is from about 1 μm to about 20 μm. In other embodiments, it is from about 1 μm to about 10 μm.

In some embodiments, at least one of the first and second polymeric matrices comprises inorganic particles. The amount of the inorganic particles is from about 0.5% to about 45% of the polymeric matrices by weight. The inorganic particles may increase the mechanical strength, the heat resistance, and the ability of maintaining lithium salts of the polymeric matrices. Furthermore, it may decrease the cost of the polymer electrolyte. In some embodiments, the inorganic particles are selected from the group consisting of silicon dioxide, zirconium dioxide, aluminum oxide, titanium dioxide, copper oxide, γ-LiAlO₂, and combinations thereof. Preferably, the average particle diameter of the inorganic particles is from about 1 nm to about 200 nm. More preferably, the average diameter is from about 5 nm to about 100 nm.

In some embodiments, the thickness of the first polymeric matrix is from about 4 μm to about 50 μm, preferably, from about 5 μm to about 25 μm. The average diameter of the pores is from about 0.01 μm to about 1 μm, preferably, from about 0.01 μm to about 0.1 μm. The porosity of the first polymeric matrix is from about 15% to about 80%, preferably, from about 20% to about 70%.

In some embodiments, the electrolyte further comprises a porous base. The porous base comprises a third polymeric matrix. The third polymeric matrix also comprises pores. The first polymeric matrix is coated on at least one surface of the porous base. The second polymeric matrix is disposed in at least part of the pores of the first polymeric matrix. At least some of the pores of the matrices are connected from one surface of the polymer electrolyte to another. The base may enhance the mechanical strength of the electrolyte and increase the safety of the battery. The connected pores allow lithium ions pass through the matrices and the electrons are to be held.

The third polymeric matrix is formed by a third polymer. The third polymer can be any suitable polymer. Preferably, the third polymer is selected from the group consisting of polyethylene, polypropylene, polyimide, polyurethane, cellulose, nylon, polytetrafluoroethylene, copolymers thereof, and combinations thereof. Preferably, the weight-average molecular weight of the third polymer is from about 20,000 to about 4,000,000 Daltons.

In one embodiment, the thickness of the porous base is from about 4 μm to about 50 μm. The average diameter of pores of the porous base is from about 0.01 μm to about 0.1 μm. The porosity of the porous base is about 20% to about 60%. Preferably, the thickness of the porous base is from about 8 μm to about 40 μm. The average diameter of the pores is from about 0.03 μm to about 0.06 μm. The porosity of the porous base is from about 30% to about 50%.

In one embodiment, the first polymeric matrix is coated on at least one surface of the porous base. In another embodiment, the first polymeric matrix is coated on the two opposite surfaces of the porous base.

The lithium salt can be any suitable lithium salt. Preferably, the lithium salt is selected from the group consisting of lithium hexafluorophosphate, lithium perchlorate, lithium tetrafluoroborate, lithium trifluoromethanesulfonate, lithium bis(trifluoromethylsulfonyl)imide, lithium bis(oxalate)borate, and combinations thereof.

In some embodiments, the lithium salt is in a form of a solution or a gel to fill into the pores of the first polymeric matrix. The lithium salt solution or gel can further comprise an organic solvent. The organic solvent is selected from the group consisting of ethylene carbonate, propylene carbonate, diethyl carbonate, dimethyl carbonate, methyl ethyl carbonate, dimethoxy carbonate, vinylene carbonate, and combinations thereof.

In some embodiments, the weight ratio of the lithium salt to the first and second polymeric matrices is from about (0.5:1) to about (15:1). Preferably, the ratio is from about (1:1) to about (8:1). More preferably, the ratio is from about (0.5:1) to about (0.8:1). In other embodiments, when the polymer electrolyte further comprises a porous base, the amount of the lithium salt is from about 30% to about 95% of the polymer electrolyte by weight; preferably, it is from about 70% to about 90%.

In some embodiments, the thickness of the polymer electrolyte is from about 4 μm to about 80 μm. Preferably, it is from about 10 μm to about 50 μm. More preferably, the thickness is from about 30 μm to about 50 μm.

A method for preparing a polymer electrolyte disclosed above is provided. The method comprises the steps of: preparing a first polymeric matrix comprising pores; applying a polymer solution to the first polymeric matrix; removing the solvent from the polymer solution so as to dispose a second polymeric matrix within the pores of the first polymeric matrix; and applying a lithium salt solution to thereby dispose lithium salt within the pores of the first polymeric matrix.

In some embodiments, the method for preparing the polymer electrolyte further comprises the step of: preparing a porous base; and applying the first polymeric matrix to at least one surface of the porous base. The first polymeric matrix can be prepared from a solution comprising the polymer of the first polymeric matrix and a first polymeric matrix solvent. The first polymeric matrix is formed on at least one surface of the porous base after the solvent is removed. Because of the first polymer fills into at least part of pores of the third polymeric matrix, the bonding strength of the first polymeric matrix and the third polymeric matrix may be enhanced.

The polymer solution that provides the first polymeric matrix comprises a first polymer and a first solvent. The polymer solution that provides the second polymeric matrix comprises a second polymer and a second solvent.

The method of applying the polymer solution can be any suitable method. For example, the method can be coating, dipping, or spraying. The weight ratio of the first polymer to the second polymer is from about 1 to about 15 controlled by the amount of the polymer solution.

In one embodiment, the first polymeric matrix is dipped into the polymer solution to absorb the solution sufficiently for about 0.1 to about 60 minutes. Then the matrix is placed into the oven at about 25° C. to about 80° C. for about 10 to about 60 minutes.

In some embodiments, at least part of the pores of the first polymeric matrix is not completely filled with the second polymer, which is achieved by controlling the composition of the second polymer, the porosity and the average pore size of the first polymeric matrix.

The first solvent can dissolve the first polymer and can be volatilized to form pores in the first polymeric matrix. In some embodiments, the first solvent is selected from the group consisting of acetone, N,N-dimethylformamide, N,N-dimethylacetamide, N-methyl-2-pyrrolidone, acetonitrile, dimethyl sulfoxide, butanone, tetrahydrofuran, and combinations thereof. The weight ratio of the first polymer to the first solvent is from about (2:100) to about (40:100). Preferably, the ratio is from about (3:100) to about (30:100).

In some embodiments, the polymer solution that provides the first polymeric matrix further comprises a first pore-forming agent that may further improve the pore-forming performance of the first polymer solution, make the pore size distribution and the pore size of the pores more uniform and form more open pores. The first pore-forming agent can be any suitable material. Preferably, the first pore-forming agent is selected from the group consisting of water, toluene, ethanol, butanol, glycerol, isopropanol, butanediol and combinations thereof. The weight ratio of the first polymer to the first pore-forming agent is from about (1:0.5) to about (1:5). Preferably, the ratio is from about (1:0.5) to about (1:2.5).

In some embodiments, the polymer solution further comprises a first inorganic particle. The weight ratio of the first polymer to the first inorganic particle is from about (1:0.1) to about (1:0.8). The first inorganic particles can be any suitable material. Preferably, the first inorganic particle is selected from the group consisting of silicon dioxide, zirconium dioxide, aluminum oxide, titanium dioxide, copper oxide, γ-LiAlO₂, and combinations thereof. The average particle diameter of the first inorganic particle is from about 1 nm to about 200 nm.

The amount of the first polymer solution is sufficient to form a matrix with a thickness of about 4 μm to about 50 μm.

The second solvent can be any suitable solvent. The second solvent can dissolve the second polymer and can be volatilized to form pores in the second polymeric matrix. In some embodiments, the second solvent is selected from the group consisting of acetone, N,N-dimethylformamide, N,N-dimethylacetamide, N-methyl-2-pyrrolidone, acetonitrile, dimethyl sulfoxide, butanone, tetrahydrofuran, and combinations thereof. The weight ratio of the second polymer to the second solvent is from about (1:100) to about (20:100). Preferably, the ratio is from about (2:100) to about (10:100).

In some embodiments, the second polymer solution further comprises a second pore-forming agent that may further improve the pore-forming performance of the second polymer solution, make the pore size distribution and the pore size of the pores more uniform and form more open pores. Preferably, the second pore-forming agent is selected from the group consisting of water, toluene, ethanol, butanol, glycerol, isopropanol, butanediol, and combinations thereof. The weight ratio of the second polymer to the second pore-forming agent is from about (1:0.1) to about (1:4). Preferably, the ratio is from about (1:0.5) to about (1:2).

In some embodiments, the second polymer solution further comprises second inorganic particles. The weight ratio of the second polymer to the second inorganic particles is from about (1:0.1) to about (1:0.5). Preferably, the second inorganic particles are selected from the group consisting of silicon dioxide, zirconium dioxide, aluminum oxide, titanium dioxide, copper oxide, γ-LiAlO₂, and combinations thereof. Preferably, the average particle diameter of the second inorganic particles is from about 1 nm to about 200 nm.

In yet another embodiment, the method for preparing the polymer electrolyte further comprises the steps of: preparing a porous base; and applying a first polymeric matrix on the surface of the porous base. The method of applying the first polymeric matrix can be any suitable methods, for example, cold pressing, hot pressing and using an adhesive.

In one embodiment, the method of applying the polymer solution into at least part of the pores of the porous base can be coating, dipping, or spraying. In one instance, the porous base is dipped into the polymer solution to absorb the solution sufficiently. Then the porous base coated with the first polymer solution is placed into the oven for heating at about 20° C. to about 200° C. for about 0.1 to about 600 minutes.

In some embodiments, at least part of the pores of the first polymeric matrix is not completely filled with the second polymer. This is achieved by controlling the composition of the second polymer, the porosity and the average pore size of the first polymeric matrix.

The method of applying the lithium salt into the first polymeric matrix can be any suitable method. In one embodiment, the first polymeric matrix is dipped into the lithium salt solution for about 0.1 to about 60 minutes.

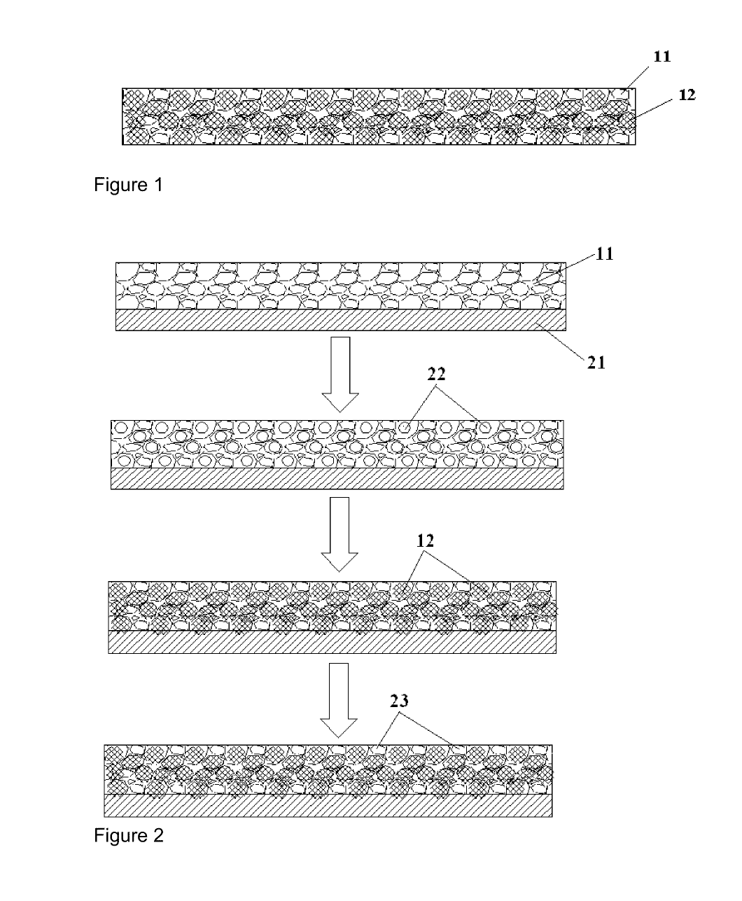

FIG. 2 shows a flowchart of preparing a polymer electrolyte according to one embodiment of the present disclosure. The polymer solution including the first polymer and the first solvent is coated onto one surface of the porous base 21. The first solvent is removed to obtain a first polymeric matrix 11 coated on the porous base 21. The polymer solution 22 including the second polymer and the second solvent is applied into the first polymeric matrix 11. The second solvent is removed to obtain the second polymeric matrix 12 disposed in the pores of the first polymeric matrix 11. Then the first polymeric matrix is dipped into a solution of lithium salt 23. Under capillary action, the lithium salt is filled within at least of part of the pores of the first polymeric matrix to obtain a polymer electrolyte.

A polymer lithium battery comprises a cathode, an anode and a polymer electrolyte disclosed above. In some embodiments, the cathode is an aluminum foil with lithium cobalt oxide, and the anode is a copper foil with graphite.

In some embodiments, the weight-average molecular weight of the polymers is measured by a method of Gel Permeation Chromatography (GPC).

### Polymer Electrolyte Embodiments 1-7

### Embodiment 1

The embodiment discloses a polymer electrolyte and a method for preparing the same.

A polyvinylidene fluoride-hexafluoropropene (PVDF-HFP) copolymer and toluene are dispersed into acetone. The mixture is stirred to form a first polymer solution. Based on the first polymer solution, the polyvinylidene fluoride-hexafluoropropene (PVDF-HFP) copolymer is 6 wt %, the toluene is 14 wt %, and acetone is 80 wt %. The polyvinylidene fluoride-hexafluoropropene (PVDF-HFP) copolymer has a weight-average molecular weight of 300,000 Daltons.

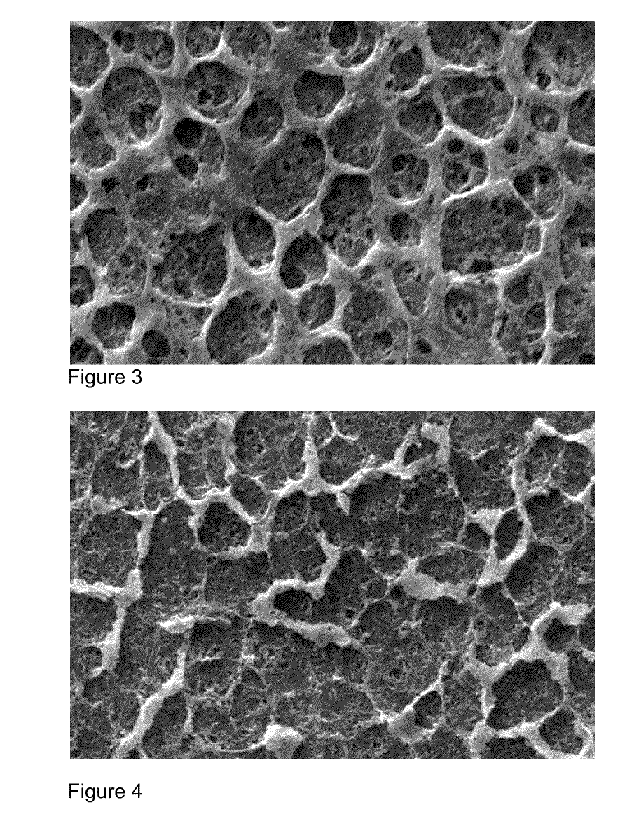

The first polymer solution is coated onto a polyethylene porous base, which has a porosity of 45%, an average porous diameter of 0.032 μm, a thickness of 16 μm, and a weight-average molecular weight of 250,000 Daltons. The coated polyethylene porous base is dried under a temperature of 25° C. for 30 minutes to form a first polymeric matrix on the polyethylene porous base, with a thickness of 12 μm. The surface morphology of the polyethylene porous base thus formed was observed by Scanning Electron Microscopy, as shown in FIG. 3.

A polyvinylidene fluoride-hexafluoropropene (PVDF-HFP) copolymer, silicon dioxide particles (with an average diameter of 10 nm), and toluene are dispersed into acetone. The mixture is stirred for 0.5 hour to form a second polymer solution. Based on the second polymer solution, the polyvinylidene fluoride-hexafluoropropene (PVDF-HFP) copolymer is 4 wt %, the acetone is 88 wt %, the toluene is 14 wt %, and the silicon dioxide particles are 1 wt %. The polyvinylidene fluoride-hexafluoropropene (PVDF-HFP) copolymer has a weight-average molecular weight of 300,000 Daltons.

The first polymeric matrix is immersed into the second polymer solution for 2 minutes, and dried under a temperature of 30° C. for 10 minutes to form a second polymeric matrix disposed in the first polymeric matrix. The matrices have a thickness of 28 μm. The weight ratio of the first polymer to the second polymer is 8:1. The surface morphology of the first and second matrices was observed by Scanning Electron Microscope, as shown in FIG. 4.

The polymeric matrices are immersed into a lithium salt solution for 20 minutes to form a polymer electrolyte. The solution comprises 1 M lithium hexafluorophosphate, and a mixture of ethylene carbonate and dimethyl carbonate at a volume ratio of (1:1).

### Embodiment 2

The embodiment discloses a polymer electrolyte and a method for preparing the same.

A polyvinylidene fluoride (PVDF) and toluene are dispersed into N-methyl-2-pyrrolidone. The mixture is stirred to form a first polymer solution. Based on the first polymer solution, the polyvinylidene fluoride (PVDF) copolymer is 6 wt %, toluene is 14 wt %, and N-methyl-2-pyrrolidone is 80 wt %. The polyvinylidene fluoride (PVDF) copolymer has a weight-average molecular weight of 500,000 Daltons.

The first polymer solution is coated on a polyethylene porous base, which is substantially the same as in EMBODIMENT 1. The coated polyethylene porous base is dried under a temperature of 60° C. for 240 minutes to form a first polymeric matrix on the polyethylene porous base, with a thickness of 12 μm.

A polyvinylidene fluoride-hexafluoropropene (PVDF-HFP) copolymer, silicon dioxide particles (with an average diameter of 10 nm), and ethanol are dispersed into acetone. The mixture is stirred for 1 hour to form a second polymer solution. Based on the second polymer solution, the polyvinylidene fluoride-hexafluoropropene (PVDF-HFP) copolymer is 4 wt %, the acetone is 88 wt %, the ethanol is 14 wt %, and the silicon dioxide particles is 1 wt %. The polyvinylidene fluoride-hexafluoropropene (PVDF-HFP) copolymer has a weight-average molecular weight of 300,000 Daltons.

The first polymeric matrix is immersed into the second polymer solution for 30 minutes, and dried under a temperature of 35° C. for 15 minutes to form a second polymeric matrix. The first and second matrices have a thickness of 28 μm. The weight ratio of the first polymer to the second polymer is 10:1.

The polymeric matrices are immersed into a solution comprising 1 M lithium hexafluorophosphate, and a mixture of ethylene carbonate and dimethyl carbonate at a volume ratio of 1, for 20 minutes to form a polymer electrolyte.

### Embodiment 3

The embodiment discloses a polymer electrolyte and a method for preparing the same.

A polymethacrylate (PMA), titanium dioxide particles (with an average particle diameter of 50 nm) and water are dispersed into N,N-dimethylformamide. The mixture is stirred to form a first polymer solution. Based on the first polymer solution, the polymethacrylate (PMA) is 10 wt %, the N,N-dimethylformamide is 83 wt %, the water is 5 wt %, and the titanium dioxide particles are 2 wt %. The polymethacrylate (PMA) has a weight average molecular weight of 1,000,000 Daltons.

The first polymer solution is coated onto a polypropylene porous base, which has a porosity of 36%, an average porous diameter of 0.046 μm, a thickness of 8 μm, and a weight average molecular weight of 1,500,000 Daltons. The coated polypropylene porous base is dried under a temperature of 80° C. for 20 minutes to form a first polymeric matrix on the polypropylene porous base, with a thickness of 25 μm.

A polyvinyl acetate (PVAc) and ethanol are dispersed into acetone. The mixture is stirred for 2 hours to form a second polymer solution. Based on the second polymer solution, the polyvinyl acetate (PVAc) is 4 wt %, the acetone is 92 wt %, and the ethanol is 4 wt %. The polyvinyl acetate (PVAc) has a weight-average molecular weight of 200,000 Daltons.

The first polymeric matrix is immersed into the second polymer solution for 5 minutes, and dried under a temperature of 30° C. for 30 min to form a second polymeric matrix with a thickness of 37 μm. The weight ratio of the first polymer to the second polymer is 15:1.

The polymeric matrices are immersed into a solution comprising 1.5 M bis(trifluoromethylsulfonyl)amine lithium salt, and a mixed solvent of ethylene carbonate, dimethyl carbonate, and ethylene carbonate at a volume ratio of 1:1:0.1, for 30 minutes to form a polymer electrolyte.

### Embodiment 4

The embodiment discloses a polymer electrolyte and a method for preparing the same.

A polyacrylonitrile (PAN) and isopropanol are dispersed into acetonitrile. Copper oxide particles (with an average particle diameter of 100 nm) are added into the mixture. The mixture is stirred to form a first polymer solution. Based on the first polymer solution, the polyacrylonitrile (PAN) is 8 wt %, the acetonitrile is 81 wt %, the isopropanol is 10 wt %, and the copper oxide particles are 81 wt %. The polyacrylonitrile (PAN) has a weight average molecular weight of 150,000 Daltons.

The first polymer solution is coated on a polytetrafluoroethylene porous base, which has a porosity of 30%, an average porous diameter of 0.052 μm, a thickness of 20 μm, and a weight average molecular weight of 600,000 Daltons. The coated polytetrafluoroethylene porous base is dried under a temperature of 70° C. for 60 minutes to form a first polymeric matrix on the polytetrafluoroethylene porous base, with a thickness of 12 um.

A polymethacrylate (PMA), aluminum dioxide particles (with an average diameter of 35 nm) and ethylene glycol are dispersed into tetrahydrofuran. The mixture is stirred for 2 hours to form a second polymer solution. Based on the second polymer solution, the polymethacrylate (PMA) is 6 wt %, the tetrahydrofuran is 90 wt %, the ethylene glycol is 3 wt %, and the aluminum dioxide particles are 1 wt %. The polymethacrylate (PMA) has a weight average molecular weight of 500,000 Daltons.

The first polymeric matrix is immersed into the second polymer solution for 10 minutes, and dried under a temperature of 25° C. for 12 minutes to form a second polymeric matrix. The matrices have a thickness of 42 μm. The weight ratio of the matrices to the polytetrafluoroethylene porous base is 1:1.

The matrices are immersed into a solution comprising 1 M LiCF₃SO₃, and a mixed solvent of ethylene carbonate, dimethyl carbonate, ethylene carbonate at a volume ratio of 1:1:0.2, for 20 minutes to form a polymer electrolyte.

### Embodiment 5

The embodiment discloses a polymer electrolyte and a method for preparing the same.

A polyvinylidene fluoride-hexafluoropropene (PVDF-HFP) copolymer and butanediol are dispersed into acetone. γ-LiAlO₂ particles (with an average diameter of 25 nm) are added into the mixture. The mixture is stirred to form a first polymer solution. Based on the first polymer solution, the polyvinylidene fluoride-hexafluoropropene (PVDF-HFP) copolymer is 3.5 wt %, the butanediol is 3 wt %, the acetone is 92.5 wt %, and the γ-LiAlO₂ particles are 1 wt %. The polyvinylidene fluoride-hexafluoropropene (PVDF-HFP) copolymer has a weight average molecular weight of 2,500,000 Daltons.

The first polymer solution is coated onto a PP/PE/PP copolymer porous base, which has a porosity of 45%, an average porous diameter of 0.035 μm, a thickness of 38 μm, and a weight average molecular weight of 1,100,000 Daltons. The coated PP/PE/PP copolymer porous base is dried under a temperature of 25° C. for 18 minutes to form a first polymeric matrix on the PP/PE/PP copolymer porous base, with a thickness of 8 μm.

A polyvinylidene fluoride-hexafluoropropene (PVDF-HFP) copolymer and butanediol are dispersed into butanone. γ-LiAlO₂ particles (with an average diameter of 25 nm) particles are added into the mixture. The mixture is stirred to form a second polymer solution. Based on the second polymer solution, the polyvinylidene fluoride-hexafluoropropene (PVDF-HFP) copolymer is 3 wt %, the butanediol is 3 wt %, the butanone is 93.5 wt %, and the γ-LiAlO₂ particles is 0.5 wt %. The polyvinylidene fluoride-hexafluoropropene (PVDF-HFP) copolymer has a weight average molecular weight of 500,000 Daltons.

The first polymeric matrix is immersed into the second polymer solution for 15 minutes, and dried under a temperature of 25° C. for 30 minutes to form a second polymeric matrix. The matrices have a thickness of 50 μm. The weight ratio of the matrices to the PP/PE/PP copolymer porous base is 6:1.

The matrices are immersed into a solution comprising 1 M bis(trifluoromethylsulfonyl)amine lithium salt, and a mixed solvent of having ethylene carbonate, dimethyl carbonate, and ethylene carbonate at a volume ratio of 1:1:0.2, for 20 minutes to form a polymer electrolyte.

### Embodiment 6

The embodiment discloses a polymer electrolyte and a method for preparing the same.

A polyvinylidene fluoride-hexafluoropropene (PVDF-HFP) copolymer and butanediol are dispersed into acetone. γ-LiAlO₂ particles (with an average diameter of 25 nm) are added into the mixture. The mixture is stirred to form a first polymer solution. Based on the first polymer solution, the polyvinylidene fluoride-hexafluoropropene (PVDF-HFP) copolymer is 6 wt %, the butanediol is 10 wt %, the acetone is 80 wt %, and the γ-LiAlO₂ particles are 4 wt %. The polyvinylidene fluoride-hexafluoropropene (PVDF-HFP) copolymer has a weight average molecular weight of 570,000 Daltons.

The first polymer solution is coated on a PP/PE/PP porous base, which has a porosity of 45%, an average porous diameter of 0.035 μm, a thickness of 36 μm, and a weight average molecular weight of 1,100,000 Daltons. The coated PP/PE/PP porous base is dried under a temperature of 30° C. for about 36 minutes to form a first polymeric matrix on the PP/PE/PP porous base, with a thickness of 10 μm.

A polyvinylidene fluoride-hexafluoropropene (PVDF-HFP) copolymer and butanediol are dispersed into acetone. γ-LiAlO₂ particles (with an average diameter of 25 nm) particles are added into the mixture. The mixture is stirred to form a second polymer solution. Based on the second polymer solution, the polyvinylidene fluoride-hexafluoropropene (PVDF-HFP) copolymer is 2 wt %, the butanediol is 3 wt %, the acetone is 94.75 wt %, and the γ-LiAlO₂ particles is 0.25 wt %. The polyvinylidene fluoride-hexafluoropropene (PVDF-HFP) copolymer has a weight average molecular weight of 590,000 Daltons.

The first polymeric matrix is immersed into the second polymer solution for 24 minutes, and dried under a temperature of 27° C. for 60 minutes to form a second polymeric matrix. The matrices have a thickness of 50 μm. The weight ratio of the matrices to the PP/PE/PP porous base is 7:1.

The matrices are immersed into a solution comprising 1 M bis(trifluoromethylsulfonyl)amine lithium salt, and a mixed solvent of ethylene carbonate, dimethyl carbonate, and ethylene carbonate at a volume ratio of 1:1:0.2, for 40 minutes to form a polymer electrolyte.

### Embodiment 7

The embodiment discloses a polymer electrolyte and a method for preparing the same.

A polyvinylidene fluoride-chlorotrifluoroethylene (PVDF-CTFE) copolymer and toluene are dispersed into acetone. Silicon dioxide particles (with an average diameter of 20 nm) are added into the mixture. The mixture is stirred to form a first polymer solution. Based on the first polymer solution, the polyvinylidene fluoride-chlorotrifluoroethylene (PVDF-CTFE) copolymer is 20 wt %, the toluene is 10 wt %, the acetone is 68 wt %, and the silicon dioxide particles are 2 wt %. The polyvinylidene fluoride-chlorotrifluoroethylene (PVDF-CTFE) copolymer has a weight average molecular weight of 1,200,000 Daltons.

The first polymer solution is coated on a polypropylene porous base, which has a porosity of 45%, an average porous diameter of 0.036 μm, a thickness of 16 μm, and a weight average molecular weight of 600,000 Daltons. The coated polypropylene porous base is dried under a temperature of 30° C. for 10 minutes to form a first polymeric matrix on the polypropylene porous base, with a thickness of 16 μm.

A polyvinylidene fluoride-chlorotrifluoroethylene (PVDF-CTFE) copolymer and butanol are dispersed into butanone. The mixture is stirred for 1.5 hours to form a second polymer solution. Based on the second polymer solution, the polyvinylidene fluoride-chlorotrifluoroethylene (PVDF-CTFE) copolymer is 5 wt %, the butanone is 85 wt %, and the butanol is 10 wt %. The polyvinylidene fluoride-chlorotrifluoroethylene (PVDF-CTFE) copolymer has a weight average molecular weight of 700,000 Daltons.

The first polymeric matrix is immersed into the second polymer solution for 10 minutes, and dried under a temperature of 60° C. for 30 minutes to form a second polymeric matrix. The matrices have a thickness of 40 μm. The weight ratio of the matrices to the polypropylene porous base is 5:1.

The matrices are immersed into a solution comprising 1 M lithium perchlorate, and a mixed solvent of ethylene carbonate, dimethyl carbonate, and ethylene carbonate at a volume ratio of 1:1:0.2, for 60 minutes to form a polymer electrolyte.

### Comparative Embodiment 1

The COMPARATIVE EMBODIMENT is substantially similar to EMBODIMENT 1, with the exception that no second polymer is applied into the first polymeric matrix. Instead, the first polymeric matrix is immersed into a lithium salt solution for 20 minutes to form a polymer electrolyte.

### Comparative Embodiment 2

The COMPARATIVE EMBODIMENT is substantially similar to EMBODIMENT 2, with the exception that no second polymer is applied into the first polymeric matrix. Instead, the first polymeric matrix is immersed into a lithium salt solution for 20 minutes to form a polymer electrolyte.

Testing

1. SEM

Surfaces of the polymeric matrices of embodiment 1 are tested with a scanning electron microscopy.

2. Porosity and Average Pore Diameter

The polymeric matrices of embodiments 1-7 and comparative embodiments 1-2 are tested, according to the standard of GBT 21650.1-2008. The porous base is removed before testing. The results are shown in Table 1.

3. Electrolyte Absorbing Ability

The polymeric matrices of embodiments 1-7 and comparative embodiments 1-2 are immersed into a lithium salt solution comprising 1M lithium hexafluorophosphate, and a mixed solvent of ethylene carbonate and dimethyl carbonate with a volume ratio of 1:1, for 1 hour respectively. After the polymeric matrices were taken out, and the electrolytes on the surface of the polymeric matrices were removed respectively, the polymeric matrices were weighed to calculate the electrolyte absorbing efficiency respectively.

The lithium salt absorbing efficiency is calculated by the formula:

Electrolyte Absorbing Efficiency (%)=(W2−W1)/W1×100%.

In the formula, W1 is the original weight of the polymeric matrices (g), W1 is the weight of the polymeric matrices after absorbing the lithium salt (g). The results are recorded in Table 1.

4. Ion Conductivity

Impedance Rb of the polymer electrolyte of embodiments 1-7 and comparative embodiments 1-2 are tested by a CHI660 electrochemical workstation with a frequency of 0.01 Hz to 106 Hz. The conductivity is calculated by the following formula:

δ=d/(S×Rb).

In the formula, d is the thickness of the electrolyte, and S is the surface area of the electrode that contacts with the electrolyte. The results are shown in Table 1.

TABLE 1

| | | | Polymeric Matrices | | | |
|---|---|---|---|---|---|---|
| | | | Including First and | | | |
| | First | | Second Polymeric | | | |
| | Polymeric Matrix | | Matrices | | Lithium | |
| | | Average | | Average | Salt | |
| | | Pore | | Pore | Absorbing | |
| | Porosity | Diameter | Porosity | Diameter | Ability | IonConductivity |
| | (%) | (μm) | (%) | (μm) | (%) | (mS/cm) |
| EMBODIMENT 1 | 60 | 0.121 | 50 | 0.08 | 340 | 1.8 |
| EMBODIMENT 2 | 55 | 0.109 | 42 | 0.069 | 390 | 2.5 |
| EMBODIMENT 3 | 51 | 0.128 | 40 | 0.078 | 364 | 2.4 |
| EMBODIMENT 4 | 80 | 0.15 | 70 | 0.1 | 360 | 3.0 |
| EMBODIMENT 5 | 54 | 0.114 | 36 | 0.058 | 370 | 2.8 |
| EMBODIMENT 6 | 30 | 0.05 | 20 | 0.01 | 350 | 1.9 |
| EMBODIMENT 7 | 62 | 0.112 | 43 | 0.065 | 385 | 2.0 |
| COMPARATIVE | 60 | 0.121 | \ | \ | 240 | 0.8 |
| EMBODIMENT 1 | | | | | | |
| COMPARATIVE | 55 | 0.112 | \ | \ | 210 | 0.7 |
| EMBODIMENT 2 | | | | | | |

As shown in Table 1, the absorbing abilities and ion conductivities of the polymeric matrices is higher than that of the prior art.

### Battery Embodiments 1-7

The battery embodiment discloses a polymer lithium rechargeable battery and a method for preparing the same.

The electrolytes of EMBODIMENTS 1-7 are disposed between anodes and cathodes. Then the battery cores are packaged to form 463446 type polymer lithium recharging batteries 1-7. The anode is an aluminum foil having 6.3 g lithium cobalt oxide, and the cathode is a copper foil having 3.0 g artificial graphite.

### Battery Comparative Embodiments 1-2

The battery comparative embodiments are prepared by a similar method in the battery embodiments 1-7, with the exception that the electrolytes are comparative batteries 1-2.

Testing of the polymer lithium rechargeable batteries

1. Resistance

The polymer lithium rechargeable batteries 1-7 and comparative batteries 1-2 (standard capacity 1100 mA×h) are tested in a resistance tester of battery (BS-VR, available from Kinte Co., Ltd. Guangzhou, P.R.C.). The results are recorded in Table 2.

2. Cycling Ability

The polymer lithium rechargeable batteries 1-7 and comparative batteries 1-2 are charged to 4.2 V. The voltage of the batteries is maintained for 10 minutes. The batteries are discharged to 3.0 V to complete a cycle respectively. The capacity retention rates after performing the cycle for 500 times are recorded in Table 2.

3. Rate Discharge Ability

The polymer lithium rechargeable batteries 1-7 and comparative batteries 1-2 are charged to 4.2 V. The voltage of the batteries is maintained for 20 minutes. The batteries are discharged to 3.0 V by 3 C current. Then the batteries are recharged to 4.2 V. The voltage is maintained for 20 minutes and the batteries are discharged to 3.0 V by 4 C current, 3 C current, 2 C current, 1 C current, and 0.2 C current, successively. Then the discharging capacities are recorded.

The ratios of the discharging capacities by 1 C current, 2 C current, 3 C current, and 4 C current to the ones discharged by 0.2 C current are shown in Table 3. The larger the capacity ratio is, the better the rate discharge ability is.

TABLE 2

| | | Capacity Retention |
|---|---|---|
| | Resistance (mΩ) | Rate |
| BATTERY 1 | 33.9 | 91.6% |
| BATTERY 2 | 32.2 | 94.0% |
| BATTERY 3 | 33.9 | 92.3% |
| BATTERY 4 | 33.7 | 91.2% |
| BATTERY 5 | 32.7 | 93.7% |
| BATTERY 6 | 32.7 | 92.9% |
| BATTERY 7 | 33.8 | 93.5% |
| COMPARATIVE BATTERY 1 | 35.2 | 88.5% |
| COMPARATIVE BATTERY 2 | 35.3 | 89.2% |

As shown in Table 2, the polymer lithium rechargeable batteries 1-7 have smaller resistance and larger remaining capacity compared to the conventional polymer lithium rechargeable batteries.

TABLE 3

| | 1 C/0.2 C | 2 C/0.2 C | 3 C/0.2 C | 4 C/0.2 C |
|---|---|---|---|---|
| BATTERY 1 | 99.1% | 96% | 90.8% | 81.3% |
| BATTERY 2 | 100% | 97.8% | 93.4% | 84.3% |
| BATTERY 3 | 99.4% | 96.5% | 91.6% | 82.6% |
| BATTERY 4 | 99.5% | 95.5% | 92.4% | 82.4% |
| BATTERY 5 | 99.8% | 96.3% | 92.4% | 81.9% |
| BATTERY 6 | 99.3% | 96.1% | 92.1% | 83.5% |
| BATTERY 7 | 99.9% | 97.5% | 93.2% | 84.0% |
| COMPARATIVE | 99.5% | 92.4% | 85.3% | 70.5% |
| BATTERY 1 | | | | |
| COMPARATIVE | 99.3% | 90.4% | 80.8% | 65.4% |
| BATTERY 2 | | | | |

As shown in Table 3, capacity ratios of batteries discharged (by 1 C current, 2 C current, 3 C current, and 4 C current) to the battery discharged by a 0.2 C current according embodiments of the present disclosure are all larger than those in the prior art. In addition, the larger the discharging current is, the more obvious the trend is.

Although the disclosure has been described in detail with reference to several embodiments, additional variations and modifications exist within the scope and spirit of the disclosure as described and defined in the following claims. Many modifications and other embodiments of the present disclosure will come to mind to one skilled in the art to which the present disclosure pertains having the benefit of the teachings presented in the foregoing description. It will be apparent to those skilled in the art that variations and modifications of the present disclosure can be made without departing from the scope or spirit of the present disclosure. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A polymer electrolyte comprising:
a first polymeric matrix comprising pores;
a second polymeric matrix disposed in at least some of the pores of the first polymeric matrix; and
a lithium salt disposed in at least some of the pores of the first polymeric matrix.

2. The electrolyte of claim 1, wherein the second polymeric matrix comprises pores, and wherein at least some of the lithium salt is disposed within at least some of the pores of the second polymeric matrix.

3. The electrolyte of claim 1, wherein the lithium salt is in a form of a solution or a gel.

4. The electrolyte of claim 1 wherein the lithium salt comprises between about 30% and about 95% of the electrolyte.

5. The electrolyte of claim 1, wherein the first polymeric matrix has an average pore diameter of about 0.01 μm to about 1 μm, wherein the first polymeric matrix has a porosity of about 15% to about 80%, and wherein the first polymeric matrix has a thickness of about 4 μm to about 50 μm.

6. The electrolyte of claim 1, wherein the weight ratio of the first polymeric matrix to the second polymeric matrix is from about 1:1 to about 15:1.

7. The electrolyte of claim 1, wherein at least one of the first and second polymeric matrices further comprises inorganic particles; and the amount of the inorganic particles is from about 0.5% to about 45% of the first or second polymeric matrices by weight.

8. The electrolyte of claim 7, wherein the inorganic particles are selected from the group consisting of silicon dioxide, zirconium dioxide, aluminum oxide, titanium dioxide, copper oxide, γ-LiAlO₂, and combinations thereof; and wherein the average particle diameter of the inorganic particles is from about 1 nm to about 200 nm.

9. The electrolyte of claim 1, wherein the first and second polymeric matrices each comprise a polymer independently selected from the group consisting of polyolefin, polymethacrylate, polyether, polysulfone, and combinations thereof.

10. The electrolyte of claim 1, wherein the polymer of the first polymeric matrix and the polymer of the second polymeric matrix comprise the same monomer, wherein the polymer of the first polymeric matrix and the polymer of the second polymeric matrix have different weight-average molecular weights, and wherein the difference between the weight-average molecular weight of the polymer of the first and second matrix is about 20,000 to about 2,000,000 Daltons.

11. The electrolyte of claim 1, wherein the lithium salt is selected from the group consisting of lithium hexafluorophosphate, lithium perchlorate, lithium tetrafluoroborate, lithium trifluoromethanesulfonate, lithium bis(trifluoromethanesulphonyl)imide, lithium bis(oxalate)borate, and combinations thereof.

12. The electrolyte of claim 1, further comprising a porous base, wherein the first polymeric matrix is disposed on at least one surface of the porous base.

13. The electrolyte of claim 12, wherein the porous base comprises a polymer selected from the group consisting of polyethylene, polypropylene, polyimide, polyurethane, cellulose, nylon, polytetrafluoroethylene, copolymers thereof, and combinations thereof.

14. A method of preparing a polymer electrolyte, comprising the steps of:
preparing a first polymeric matrix comprising pores;
applying a polymer solution to the first polymeric matrix;
removing the solvent from the polymer solution so as to dispose a second polymeric matrix within the pores of the first polymeric matrix; and
applying a lithium salt solution to thereby dispose lithium salt within the pores of the first polymeric matrix.

15. The method of claim 14, wherein the amount of the lithium salt is about 30% to about 95% of the polymer electrolyte by weight.

16. The method of claim 14, further comprising the step of:
providing a porous base;
and wherein the step of providing a first polymeric matrix comprises
applying a solution comprising the polymer of the first polymeric matrix and a first polymeric matrix solvent to at least one surface of the porous base; and
removing the first polymeric matrix solvent so as to form the first polymeric matrix on the at least one surface of the porous base.

17. The method according to claim 16, wherein the first and second polymeric matrices each comprise a polymer independently selected from the group consisting of polyolefin, polymethacrylate, polyether, polysulfone, and combinations thereof; the solvents of the polymer solutions are each independently selected from the group consisting of acetone, N,N-dimethylformamide, N,N-dimethylacetamide, N-methyl-2-pyrrolidone, acetonitrile, dimethyl sulfoxide, butanone, tetrahydrofuran, and combinations thereof; and wherein at least one of the polymer solutions further comprise a pore-forming agent; and wherein the pore-forming agent is selected from the group consisting of water, toluene, ethanol, butanol, glycerol, isopropanol, butanediol, and combinations thereof.

18. The method according to claim 16, wherein at least one of the polymer solutions further comprises inorganic particles, and wherein the amount of the inorganic particles is about 0.5% to about 45% of the first and second polymeric matrices by weight.

19. The method according to claim 18, wherein the inorganic particles are selected from the group consisting of silicon dioxide, zirconium dioxide, aluminum oxide, titanium dioxide, copper oxide, γ-LiAlO₂, and combinations thereof; and wherein the average particle diameter of the inorganic particles is from about 1 nm to about 200 nm.

20. A battery comprising:
a cathode;
an anode; and
a polymer electrolyte comprising:
a first polymeric matrix comprising pores;
a second polymeric matrix disposed in at least some of the pores of the first polymeric matrix; and
a lithium salt disposed in at least some of the pores of the first polymeric matrix.
